(19) United States
(12) Patent Application Publication
(10) Pub. No.: US 2007/0059403 A1
(43) Pub. Date: Mar. 15, 2007

(54) Method of production of croissant type pastry products with charcuterie and cream cheese filing, and with incorporation of olive oil into the dough

(75) Inventor: Emmanouil Domazakis, Rethymnon (GR)

Correspondence Address: KRIEG DEVAULT LLP, ONE INDIANA SQUARE, SUITE 2800, INDIANAPOLIS, IN, 46204-2079, US

(73) Assignee: CRETA FARM ANONIMOS VIOMICHANIKI & EMPORIKI ETAIRE, Rethymnon (GR)

(21) Appl. No.: 10/577,813

(22) PCT Filed: Jun. 18, 2004
(86) PCT No.: PCT/GR04/00034

§ 371 Date: Jul. 31, 2006

(30) Foreign Application Priority Data
Oct. 14, 2003 (GR) 20030100415

(51) Int. Cl. A21D 13/00

(52) U.S. Cl. 426/94

(57) ABSTRACT

Method for the preparation of croissant type pastries with cooked meat and cream cheese filling, with direct or indirect olive oil incorporation to the dough, whose storage and transport is performed under refrigeration. This method includes the following production stages: 1. Preparation of specific emulsion for the olive oil incorporation. 2. Preparation of liquid leaven for stably adjusting the pH using biological means and creating conditions for improved conservation and organoleptic properties (flavor, taste, softness) of the refrigerated final product. 3. Preparation and maturation of the main croissant type dough in two phases as well as shaping, multiplication and ironing of sheets at specified thickness. 4. Cutting of the dough, automatic incorporation of cooked meat, folding and prolonged maturation. 5. Baking, pre-cooking and injection of cream cheese under aspectic conditions. 6. Packing in protective atmosphere of inert gases followed by storage and transportation under refrigeration.

The present invention refers to the production of croissant type pastries, with cooked meat and cream cheese filling, bearing the following traits:
1. The use of olive oil during dough preparation instead of the high melting point animal fats or margarine usually used.
2. The use of emulsion, facilitating the olive oil incorporation to the dough. The emulsion used is characterized by its high stability and provides the dough with extra mechanical strength for its further processing.
3. The use of liquid leaven prepared by a specific combination of microbial cultures, which ensure the consistency of the primary culture as well as that of the organoleptic traits of the final product (structure, colour, taste and flavour).
4. The application of suitable technological procedures and processes developed, aiming at:
   a. Dough preparation of high mechanical strength facilitating its further processing.
   b. Stabilization of the uniform honeycomb structure of the final product in conduction with sustaining its organoleptic traits of fressness upon storage.
   c. Stable incorporation into the dough of the directly or indirectly mixed olive oil (Differentiating Factor) and maximum preservation of its organoleptic, physicochemical and nutritional characteristics.
   d. Long-term conservation (at least 30 days) under refrigeration (4°-6° C.).

### OBJECTIVE OF THE INVENTION

This invention is aiming at the production of croissant type pastries, with cooked meat and cream cheese filling, with:
1. The direct or indirect olive oil incorporation instead of the high melting point animal fats or margarine usually used
2. The addition of combined technology auxiliary products and
3. The application of specific technological processes.
   The aforementioned were achieved with the use of an emulsion of specific composition characterized by high stability which confers supreme mechanical resistance to the dough for its further processing as well as with the use of liquid leaven prepared by a specific combination of microbial cultures which ensure the consistency of the primary culture as well as that of the organoleptic features and the long-term conservation of the final product.

The present invention provides croissant type pastries with direct or indirect olive oil incorporation to the dough, cooked meat and cream cheese filling according to the following preparation protocol:

### DESCRIPTION OF PRODUCTION PHASES

Phase 1

Initially the emulsion and the liquid leaven are prepared. The emulsion (step 1) is prepared by distilled monoglycerides homogenized in a high-speed mixer in the presence of 40°-45° C. water. This is followed by the addition of olive oil, dextrose, fructose and egg yolk. The liquid leaven (step 2) is prepared by the inoculation of rye flour with specially formulated microbial cultures followed by incubation at 32° C. for 18-24 hours in a dough kneader.

Phase 2

This is the main production phase; Flour and water are combined with liquid leaven, prepared as previously described (step 2), and kneaded together. The resulting dough is then transferred to maturation chambers where it remains for 120 minutes at 30° C. and Relative Humidity (RH) 80%. Further on, the rest of the ingredients (i.e. flour, water, emulsion (step 1), sugar, eggs, olive oil and baker's leaven) are added. The mature dough is transferred to the shaping machine (extruder) and rolled into shape. The shaped dough passes through a series of dough rotors and increases in thickness. Dough sheets are then flattened down to 2.8-3 mm. The sheets that result from this procedure are now placed in a cutting-filling-folding machine where they acquire the croissant shape and simultaneously the cooked meat filling is incorporated. The folded croissants are placed into tin trays equipped with grooves (moulds) and transferred to maturation chambers, where they are left to mature for 8 hours at 28° C. and RH 80%. The baking takes place next, at 180° C. for 12-15 min. The baked product is then cooled down in the presence of high microbial quality air. The cream cheese is then automatically injected into the product. Finally the product is packed in a modified atmosphere consisting of protective gases (CO₂/N₂), labeled and stored under refrigeration at 4°-6° C.

The croissant type dough with olive oil, cooked meat and cream cheese filling, prepared according to the present protocol has excellent stability and homogeneity as far as structure is concerned due to the specific composition of the emulsion used for the indirect olive oil mixing, the use of liquid leaven and the application of two phases of extended maturation prior to and after the shaping of the dough. The physicochemical features of the olive oil that these products contain remain unspoiled due to the low temperatures applied during production thus contributing to the preservation of the initial freshness of the product.

1. Method for the preparation of croissant type pastries with cooked meat and cream cheese filling characterized by the direct and indirect incorporation of olive oil during the preparation of the dough. The olive oil replaces the high melting point animal fat or the margarine normally used. This method includes the following stages:
a. Preparation of an emulsion of distilled monoglycerides in the presence of 40-45° C. water, by homogenization in a high-speed mixer, subsequently, addition of olive oil, dextrose, fructose and egg yolk.
b. Preparation of liquid leaven as follows: inoculation of rye flour substrate with specially formulated microbial cultures followed by incubation at 32° C. for 18-24 hours in a dough kneader.
c. Mixing of flour and water with a quantity of liquid leaven, which has been prepared as described above (b), and subsequent kneading.
d. The kneaded dough is moved to maturation chambers, where it remains for 120 minutes at a temperature of 30° C. and RH 80%. After that, the remaining ingredients (flour, water, emulsion (a), sugar, eggs, olive oil, baker's leaven) are added to it.
e. The mature dough is transferred to the shaping machine (extruder) and rolled into shape.
f. The shaped dough passes through a series of dough rotors and increases in thickness. Dough sheets are then flattened down to 2.8-3 mm.
g. The sheets that result from this procedure are now placed in a cutting-filling-folding machine where they acquire the croissant shape and simultaneously the cooked meat filling is incorporated.
h. The folded croissants are placed into tin trays equipped with grooves (moulds) and transferred to maturation chambers, where they are left to mature for 8 hours at 28° C. and RH 80%.
i. The baking takes place next at 180° C. for 12-15 min.
j. The baked product is then cooled down in the presence of high microbial quality air. The cream cheese is then automatically injected into the product.
k. Finally the product is packed in a modified atmosphere consisting of protective gases (CO₂/N₂), labeled and stored under refrigeration at 4°-6° C.

2. The croissant type pastries with cooked meat, cream cheese filling and with olive oil incorporated into the dough, which are manufactured according to the protocol of claim (1).
